(19) United States
(12) Patent Application Publication
(10) Pub. No.: US 2020/0241672 A1
(43) Pub. Date: Jul. 30, 2020

(54) Detecting a Touch Input to a Surface

(71) Applicant: Apple Inc., Cupertino, CA (US)

(72) Inventors: Igal Kushnir, Hod-Hasharon (IS); Ofir Degani, Haifa (IS)

(21) Appl. No.: 16/639,642

(22) PCT Filed: Aug. 24, 2017
(86) PCT No.: PCT/US2017/048296

§ 371 Date: Feb. 17, 2020

(30) Foreign Application Priority Data
Aug. 18, 2017 (US) PCT/US2017/047495

(51) Int. Cl. G06F 3/046; G01S 13/88

(52) U.S. Cl. CPC G06F 3/046; G01S 2013/0245; G01S 13/88

(57) ABSTRACT

A device for detecting a touch input to a surface comprises at least one radar transmitter component configured to transmit electromagnetic radiation in a radio frequency spectrum. The device further comprises at least one radar receiver component configured to receive a portion of the electromagnetic radiation reflected by an object performing the touch input to the surface. The device further comprises a control module configured to receive information related to the portion of the electromagnetic radiation received by the at least one radar receiver component. The control module is further configured to detect the touch input to the surface based on the information related to the portion of the electromagnetic radiation received by the at least one radar receiver component.

### FIELD

Examples relate to a device, an apparatus and a method for detecting a touch input to a surface, to a touch screen module, a touch screen apparatus, mobile terminals and a touch screen computer, more specifically, but not exclusively, to detecting a touch input to a surface based on a received portion of transmitted electromagnetic radiation.

### BACKGROUND

Touch screen devices have become a major product category among general computing devices, comprising, among others, mobile phones, tablets and touch screen computers. In many cases, capacitive touch screens are used for high quality touch screens, which may significantly add to both the thickness and cost of the screen.

### BRIEF DESCRIPTION OF THE FIGURES

Some examples of apparatuses and/or methods will be described in the following by way of example only, and with reference to the accompanying figures, in which

FIG. 1 shows a block diagram of an example of a device for detecting a touch input to a surface and of an apparatus for detecting a touch input to a surface;

FIG. 2 shows a block diagram of an example of a touch screen module and of a touch screen apparatus;

FIG. 3a shows a block diagram of an example of a mobile terminal comprising a touch screen module or a touch screen apparatus;

FIG. 3b shows a block diagram of an example of a touch screen computer comprising a touch screen module or a touch screen apparatus;

FIG. 4 shows a flow chart of a method for detecting a touch input to a surface;

FIG. 5 shows a block diagram of a smart phone with four radar sensors;

FIG. 6 shows a schematic diagram of a radar phased array antenna end-fire radiation pattern;

FIG. 7 shows of a schematic diagram of touch screen scanning and detecting a human finger;

FIG. 8 shows a schematic diagram of an object scanned by two radar detectors;

FIG. 9 shows a schematic diagram of a radar detector; and

FIG. 10 shows a schematic block diagram of a PC comprising small radar detectors.

### DETAILED DESCRIPTION

Various examples will now be described more fully with reference to the accompanying drawings in which some examples are illustrated. In the figures, the thicknesses of lines, layers and/or regions may be exaggerated for clarity.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

It will be understood that when an element is referred to as being “connected” or “coupled” to another element, the elements may be directly connected or coupled or via one or more intervening elements. If two elements A and B are combined using an “or”, this is to be understood to disclose all possible combinations, i.e. only A, only B as well as A and B. An alternative wording for the same combinations is “at least one of A and B”. The same applies for combinations of more than 2 Elements.

The terminology used herein for the purpose of describing particular examples is not intended to be limiting for further examples. Whenever a singular form such as “a,” “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises,” “comprising,” “includes” and/or “including,” when used, specify the presence of the stated features, integers, steps, operations, processes, acts, elements and/or components, but do not preclude the presence or addition of one or more other features, integers, steps, operations, processes, acts, elements, components and/or any group thereof.

Unless otherwise defined, all terms (including technical and scientific terms) are used herein in their ordinary meaning of the art to which the examples belong.

At least some examples relate to a device, an apparatus, a method and a computer program for detecting a touch input to a surface, to a touch screen module, a touch screen apparatus, mobile terminals and a touch screen computer.

In at least some examples, the detection of the touch input may be based on using radar, e.g. by transmitting electromagnetic radiation and receiving a portion of the electromagnetic radiation reflected by nearby objects, e.g. by a finger performing the touch input. To conserve energy, the detecting of the touch input may be performed in two time intervals: In a first time interval, the surface may be coarsely and sparsely scanned for objects approaching the surface, and in the second time interval, a more precise detection (e.g. with a higher temporal resolution) may be performed to determine the position of the touch input.

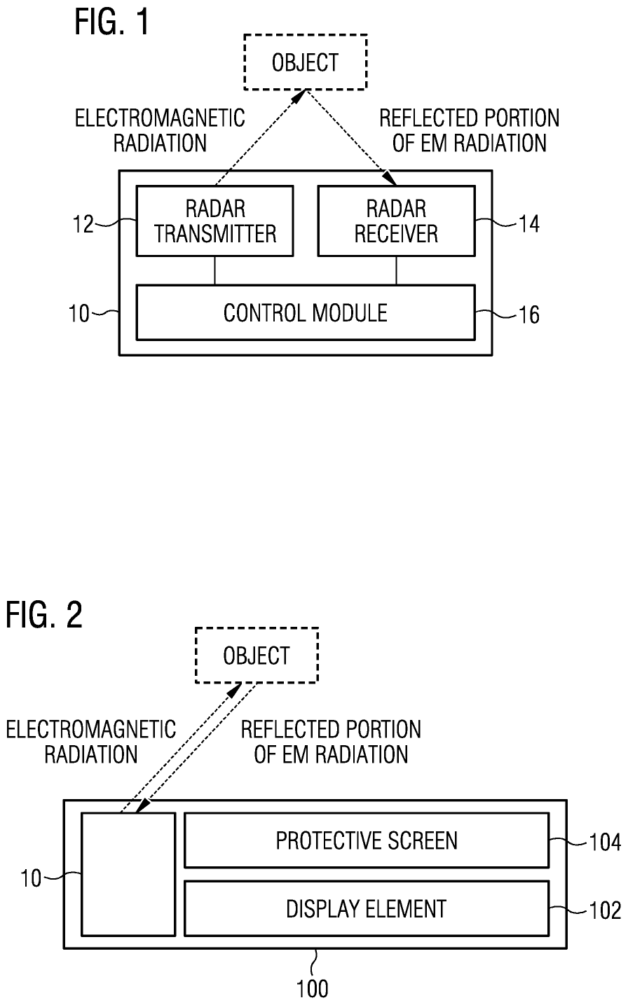

FIG. 1 illustrates examples of a device 10 for detecting a touch input to a surface and of an apparatus 10 for detecting a touch input to the surface. In the following, multiple examples will be described in detail. The described device 10 corresponds to an apparatus 10 for detecting a touch input to a surface. The components of the apparatus 10 are defined as component means, which correspond to the respective structural components of the device 10.

FIG. 1 illustrates a block diagram of an example of a device 10 for detecting a touch input to a surface. The device 10 comprises at least one radar transmitter component 12 configured to transmit electromagnetic radiation in a radio frequency spectrum. The device 10 further comprises at least one radar receiver component 14 configured to receive a portion of the electromagnetic radiation reflected by an object performing the touch input to the surface. The device 10 further comprises a control module 16 configured to receive information related to the portion of the electromagnetic radiation received by the at least one radar receiver component 14. The control module 16 is further configured to detect the touch input to the surface based on the information related to the portion of the electromagnetic radiation received by the at least one radar receiver component 14. The at least one radar transmitter component 12 and the at least one radar receiver component 14 are coupled to the control module 16.

Using radar to detect the touch input to the surface may allow the construction of thinner touch screens at a cost that may be lower than a cost of capacitive touch screens, resistive touch screens, or other touch screens. Furthermore, through adjustments to a region, in which the touch may be detected, through adjustments to a temporal and/or to a spatial resolution, an energy consumption of a radar-based touch screen may be lower than an energy consumption of a capacitive touch screen. Additionally, larger touch screens may be constructed using radar technology with little or no loss to a precision of the detection of the touch.

For example, the touch input may be a touch or contact of an object (e.g. of a finger or other limb of a user) with the surface. In at least some examples, the touch or contact may be imminent, e.g. the object may be in a proximity of the surface or the object may be about to touch the surface. The surface may be a display element, e.g. a display protected by a protective screen or protective cover. Alternatively, the surface may be any surface dedicated to a touch input, e.g. a surface of a graphics tablet or a surface, on which the layout of an application or of an input device is projected. In at least some examples, the surface may be (substantially) planar. Alternatively, the surface may be structured, e.g. of variable height.

The at least one radar transmitter component 12 may be comprised in a radar transceiver component, e.g. in a Radio-frequency Front End Module (RFEM). The at least one radar transmitter component 12 may be implemented as any means for transmitting, one or more transmitter units, one or more transmitter devices and it may comprise typical transmitter components, such as one or more elements of the group of one or more Low-Noise Amplifiers (LNAs), one or more Power Amplifiers (PAs), one or more filters or filter circuitry, one or more diplexers, one or more duplexers, one or more Analog-to-Digital converters (A/D), one or more Digital-to-Analog converters (D/A), one or more modulators or demodulators, one or more mixers, one or more antennas, etc. For example, the at least one radar transmitter component 12 may be configured to transmit the electromagnetic radiation using a synthetic aperture radar. This may improve an overall resolution of the detection of the touch. For example, the at least one radar transmitter component may be configured to transmit the electromagnetic radiation as continuous-wave radar radiation or as frequency-modulated continuous-wave radar radiation.

For example, the at least one radar transmitter component 12 may comprise at least one phased array antenna. This may enable sweeping a region. The transmitters 12 and receivers 14 may be capable of working as a phased array, which may allow sweeping the beam. The at least one phased array antenna may comprise a plurality of antenna elements of the array. For example, the at least one phase array antenna may comprise at least 8 (or at least 16, at least 32, at least 48, at least 96, at least 256, at least 512, at least 1024) antenna elements. For example, the electromagnetic radiation transmitted via the at least one phase array antenna may comprise a different phase for different antenna elements of the plurality of antenna elements, based on a desired transmission angle of the electromagnetic radiation. For example, the at least one radar transmitter component 12 may be configured to adjust a transmission angle of the electromagnetic radiation to a desired transmission angle using the at least one phased array antenna. For example, the at least one radar transmitter component 12 may be configured to adjust a phase difference for the plurality of antenna elements based on the desired transmission angle. For example, the at least one radar transmitter components 12 may be configured to sweep a region with the electromagnetic radiation by changing the desired transmission angle and correspondingly adjusting the phase difference for the plurality of antenna elements. For example, an electromagnetic radiation pattern of the at least one phased array antenna may be a directed pattern extending along the surface. The RFEMs (RF front end module) comprising the transmitters 12 (transmitter components 12) and receivers 14 (receiver components 14), may have good end-fire radiation (in parallel to the surface/glass), due to adjustments of each antenna in the phased array for good end-fire radiation (this allows us detecting efficiently when the object/finger is touching the glass). For example, the at least one phase array antenna may be configured to transmit the directed pattern extending along the surface.

For example, sweeping a region may comprise directing the transmission of the electromagnetic radiation across the region, e.g. in a continuous motion. In at least some examples, sweeping the region may comprise transmitting the electromagnetic radiation using a plurality of transmission angles to cover the region. The at least one radar transmitter component 12 may be configured to sweep the region with the electromagnetic radiation, e.g. using the at least one phased array antenna.

For example, the electromagnetic radiation may correspond to electromagnetic waves in the radio or microwaves domain. For example, a wavelength of the electromagnetic radiation may be between 1 mm and 1 cm (or between 2 mm and 7.5 mm, between 2 mm and 4 mm). The at least one radar transmitter component 12 may be configured to transmit the electromagnetic radiation in a millimeter band. For example, the electromagnetic radiation may be in the extremely high frequency (EHF) spectrum between 30 GHz and 300 GHz.

In at least some examples, the at least one radar receiver component 14 may be configured to detect and/or measure electromagnetic radiation (e.g. electromagnetic radiation within the radio frequency wavelength spectrum) incident to at least one antenna of the radar receiver component 14 to receive the portion of the electromagnetic radiation reflected by the object performing the touch input to the surface. In various examples, the at least one radar receiver component 14 may be configured to receive the portion of the electromagnetic radiation reflected by the object before the object touches the surface, e.g. when it comes into proximity of the surface. For example, other portions of the electromagnetic radiation may be absorbed by the object (or other objects and surroundings), or the other portions may be deflected and might not be received by the at least one radar receiver component 14. For example, the portion of the electromagnetic radiation reflected by the object may be a portion of the electromagnetic radiation transmitted by the at least one transmitter component 12, reflected by the object and received within a pre-defined timespan after transmitting by the at least one radar transmitter component. Additionally or alternatively, the portion of the electromagnetic radiation reflected by the object may be a portion of the electromagnetic radiation transmitted by the at least one transmitter component 12 and directly reflected by the object towards the at least one radar transmitter component.

The at least one radar receiver component 14 may be implemented as any means for receiving, one or more receiver units, one or more transmitter devices and it may comprise typical receiver components, such as one or more elements of the group of one or more Low-Noise Amplifiers (LNAs), one or more filters or filter circuitry, one or more diplexers, one or more duplexers, one or more Analog-to-Digital converters (A/D), one or more Digital-to-Analog converters (D/A), one or more modulators or demodulators, one or more mixers, one or more antennas, etc.

In at least some examples, the device 10 may comprise at least two (or at least three, at least four) radar transmitter components 12 and/or at least two (or at least three, at least four) radar receiver components 14. For example, the device 10 may comprise one or more radar transceiver components, each comprising a radar transmitter component 12 and a radar receiver component 14. Alternatively, the at least one radar transmitter component 12 and the at least one radar receiver component 14 may be arranged separately, e.g. on opposing sides of the surface. For example, a radar receiver component 14 may be configured to receive portions of the electromagnetic radiation transmitted by a single radar transmitter component 12. Alternatively, a radar receiver component 14 may be configured to receive portions of the electromagnetic radiation transmitted by a plurality of radar transmitter components 12.

In at least some examples the control module 16 may be implemented using one or more controlling units, one or more controlling devices, one or more means for controlling, one or more processing units, one or more processing devices, any means for processing, such as a processor, a computer or a programmable hardware component being operable with accordingly adapted software. In other words, the described function of the control module 16 may as well be implemented in software, which is then executed on one or more programmable hardware components. Such hardware components may comprise a general purpose processor, a Digital Signal Processor (DSP), a micro-controller, etc.

For example, the information related to the portion of the electromagnetic radiation received by the at least one radar receiver component 14 may comprise amplitude information and/or phase information related to the portion of the electromagnetic radiation received by the at least one radar receiver component, e.g. amplitude information and/or phase information for electromagnetic radiation within the radio or microwaves domain. Alternatively or additionally, the information related to the portion of the electromagnetic radiation received by the at least one radar receiver component 14 may comprise information related to a phase shift (e.g. relative to the transmitted electromagnetic radiation) of the portion of the electromagnetic radiation reflected by the object, e.g. information related to a phase shift of the portion of the electromagnetic radiation reflected by the object at a beam angle of a sweep. Alternatively or additionally, the information related to the portion of the electromagnetic radiation received by the at least one radar receiver component 14 may comprise information related to a power reading at the at least one radar receiver component 14, e.g. information related to a power reading at the at least one radar receiver component 14 at a beam angle of a sweep.

The control module 16 may be configured to detect the touch input to the surface based on a phase shift of the received portion of the electromagnetic radiation relative to the transmitted electromagnetic radiation. This may enable the control module 16 to determine a distance of the object. For example, the control module 16 may be configured to determine a distance of the object based on the phase shift of the received portion of the electromagnetic radiation relative to the transmitted electromagnetic radiation. In some examples, the control module 16 may be configured to determine the phase shift based on the transmitted electromagnetic radiation and based on the received portion of the electromagnetic radiation. In some other examples, the control module 16 may be configured to obtain information related to the phase shift from the at least one radar receiver component 14. For example, the at least one radar receiver component may be configured to determine the information related to the phase shift based on the transmitted electromagnetic radiation and based on the received portion of the electromagnetic radiation.

In at least some examples, the control module 16 is configured to determine a position of the object relative to the surface based on the information related to the portion of the electromagnetic radiation received by the at least one radar receiver component 14. This may enable using the device 10 within a touch screen, e.g. for touch input to a device. For example, the control module 16 may be configured to determine the position of the object relative to the surface based on the phase shift of the received portion of the electromagnetic radiation relative to the transmitted electromagnetic radiation. For example, the control module 16 may be configured to determine the position of the object relative to the surface based on an electromagnetic radiation sweep of a region performed by the at least one radar transmitter component. In various examples, the control module 16 may be configured to determine the position of the object within a two-dimensional or within a three-dimensional coordinate system. For example, the two-dimensional coordinate system may represent two lateral directions in parallel to the surface. For example, the two lateral directions may be orthogonal. For example, the three-dimensional coordinate system may represent two lateral directions in parallel to the surface and one vertical direction orthogonal to the surface.

In various examples, the control module 16 is configured to determine the position of the object at a distance of up to 30 cm (or up to 20 cm, up to 10 cm, up to 5 cm) from the surface. For example, the control module 16 may be configured to determine the position of the object at a distance of not more than 30 cm (or not more than 20 cm, not more than 10 cm, not more than 5 cm) from the surface. For example, the at least one radar transmitter component 12 may be configured to transmit the electromagnetic radiation to encounter objects at a distance of up to 30 cm (or up to 20 cm, up to 10 cm, up to 5 cm) from the surface. Alternatively, the control module 16 may be configured to determine the position of the object at a distance of more than 30 cm from the surface or to detect a presence of the object in proximity of the surface at a distance of more than 30 cm from the surface.

The control module 16 may be configured to provide information related to the position of the object via an interface. The information related to the position of the object may comprise two-dimensional coordinates of the object or three-dimensional coordinates of the object, for example. The interface may correspond to one or more inputs and/or outputs for receiving and/or transmitting information, which may be in digital (bit) values according to a specified code, within a module, between modules or between modules of different entities. For example, the interface may be implemented by any interface unit or interface unit, any means for providing or obtaining, or any means for transmitting or receiving.

In various examples, the at least one radar transmitter component 12 may be configured to sweep a region with the electromagnetic radiation. Sweeping the region may enable a detection of objects within the region. For example, the region may encompass the entire surface. Alternatively, the region may be limited to a portion of the surface. For example, the at least one radar transmitter component 12 may be configured to transmit the electromagnetic radiation along a range of angles and the region may be comprised within the area of propagation of the electromagnetic radiation defined by the range of angles.

In at least some examples, the control module 16 may be configured to specify the region to be sweeped by the at least one radar transmitter component 12 based on the detected touch input. This may enable a more precise determination of the position of the object at a higher temporal resolution and/or at a lower energy consumption. For example, the control module 16 may be configured to estimate the region, in which the touch has occurred or will likely occur, and to specify the region to be sweeped based on the estimated region. The control module 16 may be configured to control properties of the sweep based on at least one element of the group of a number of detected touches to the surface, a desired spatial or temporal resolution of the touch detection and a type of application to be controlled by the detected touch. This may enable a situation-dependent improvement of the detection, e.g. based on whether a current focus is on accuracy, delay or energy consumption. For example, the properties of the sweep to be controlled may comprise at least one element of the group of one or more regions to be sweeped, one or more ranges of angles of the sweeped, a refresh rate or repetition rate of the sweep, a temporal resolution of the sweep, a spatial resolution of the sweep and an energy output of the sweep. For example, the control module 16 may be configured to specify a plurality of regions based on the number of detected touches to the surface. For example, the plurality of regions may be sweeped based on a plurality of properties and/or using a plurality of radar transmitter components 12.

In various examples, the control module 16 may be configured to provide information related to a phase shift of the portion of the electromagnetic radiation reflected by the object at a beam angle of the sweep via the interface. For example, the information related to the phase shift of the portion of the electromagnetic radiation reflected by the object at a beam angle of the sweep may comprise tuples of a digital representation of the phase shift at a plurality of angles of the sweep. For example, the plurality of angles may comprise a lower number of angles in a first time interval (e.g. when the object is further away from the surface) and a higher number of angles in a second time interval (e.g. when the object is closer to the surface). This may enable further processing within a central processing unit of a device comprising a touch screen and the device 10 and a lower complexity implementation of the control module 16.

Alternatively or additionally, the control module 16 may be configured to provide information related to a power reading at the at least one radar receiver component 14 at a beam angle of the sweep via the interface. For example, the information related to the phase shift of the portion of the electromagnetic radiation reflected by the object at a beam angle of the sweep may comprise tuples a digital representation of the power reading at a plurality of angles of the sweep. For example, the at least one radar receiver component 14 may be configured to measure the power reading for the plurality of angles, and to provide information related to the power reading to the control module 16. This may enable further processing within a central processing unit of a device comprising a touch screen and the device 10 and a lower complexity implementation of the control module 16.

In at least some examples, the control module 16 may be configured to detect a presence of the object in proximity of the surface within a first time interval. For example, the control module 16 may be configured to detect the presence of the object in proximity of the surface based on a coarse sweep of the proximity of the surface, e.g. based on a sweep with a low spatial resolution and/or based on a sweep with a low temporal resolution. The control module 16 may be configured to determine the position of the object (e.g. relative to the surface) within a second time interval. This may enable an energy-efficient detection of the object within the first time interval and a (more) precise determination of the position of the object within the second time interval.

For example, the at least one radar transmitter component 12 may be configured to sweep a first region with the electromagnetic radiation during the first time interval. The at least one radar transmitter component 12 may be configured to sweep a second region during the second time interval. The first region may be larger than the second region. This may enable a higher temporal resolution (and/or a higher spatial resolution at the same temporal resolution) within the second time interval. For example, the first region may be at least twice (or at least three times, at least four times) as large as the second region. For example, the first region may be based on a first larger range of transmission angles of the sweep, and the second region may be based on a second smaller range of transmission angles of the sweep. For example, the control module 16 may be configured to estimate the second smaller range of transmission angles based on the portion of the electromagnetic radiation received within the first time interval.

In various examples, the at least one radar transmitter component 12 may be configured to sweep a region (e.g. the first region) during the first time interval using a first lower temporal resolution. The at least one radar transmitter component 12 may be configured to sweep a region (e.g. the second region or the same region) during the second time interval using a second higher temporal resolution. This may enable an energy-efficient coarse sweep during the first time interval. For example, a time interval between successive sweeps of the first lower temporal resolution may be at least twice (or at least three times, at least four times) as large as a time interval between successive sweeps of the second higher temporal resolution.

In at least some examples, the control module 16 may be configured to estimate a position of the object (e.g. relative to the surface) within the first time interval. For example, the control module 16 may be configured to estimate the position (e.g. based on the sweep of the region or of the first region) of the object using a first lower spatial resolution and/or using a first lower temporal resolution within the first time interval, and to determine the position of the object using a second higher spatial resolution and/or using a second higher temporal resolution within the second time interval. The control module 16 may be configured to specify a region to be sweeped by the at least one radar transmitter component 12 within the second time interval based on the estimated position of the object. For example, the control module 16 may be configured to control the at least one radar transmitter component 12 to limit the sweep within the second time interval to a region surrounding the estimated position of the object. This may enable an operation with a reduced energy consumption within the first time interval and an operation with an improved spatial and/or temporal resolution within the second time interval.

In various examples, a region, e.g. the first region and/or the second region, may be defined in parallel to the surface. Additionally, a height of the region may be defined orthogonal to the surface, creating a three-dimensional region. For example, a height of the first region may be larger than a height of the second region.

The spatial resolution may refer to a distance between discernible positions of the object, and may e.g. be based on a number and/or distance of angles of a sweep of the at least one radar transmitter component 12. A (first) lower spatial resolution may comprise a larger distance between discernible positions of the object than a (second) higher spatial resolution. The temporal resolution may refer to a time interval between successive electromagnetic radiation transmissions or electromagnetic radiation sweeps of the at least one radar transmitter component 12. A (first) lower temporal resolution may comprise a larger time interval between successive electromagnetic radiation transmissions or electromagnetic radiation sweeps than a (second) higher temporal resolution.

In at least some examples, lateral dimensions or a lateral direction may be defined in parallel to the surface (or to an intersection of the surface, if the surface is non-planar). Vertical dimensions or a vertical direction may be defined orthogonal to the surface (or to an intersection of the surface, if the surface is non-planar).

FIG. 1 further shows an example of an apparatus 10 for detecting a touch input to a surface. The apparatus 10 comprises at least one means for transmitting 12 electromagnetic radiation in a radio frequency spectrum. The apparatus 10 further comprises at least one means for receiving 14 a portion of the electromagnetic radiation reflected by an object performing the touch input to the surface. The apparatus 10 further comprises a means for controlling 16 configured for receiving information related to the portion of the electromagnetic radiation received by the at least one means for receiving 14. The means for controlling 16 is further configured for detecting the touch input to the surface based on the information related to the portion of the electromagnetic radiation received by the at least one means for receiving 14.

FIG. 2 illustrates example of a touch screen module 100 and of a touch screen apparatus 100. In the following, multiple examples will be described in detail. The described touch screen module 100 corresponds to a touch screen apparatus 100. The components of the touch screen apparatus 100 are defined as component means, which correspond to the respective structural components of the touch screen module 100.

FIG. 2 illustrates a block diagram of a touch screen module 100 comprising a device 10, e.g. a device 10 described in connection with FIG. 1. The surface to be touched corresponds to a display element 102 or to a protective screen 104 covering the display element 102. Radar, e.g. short-range radar might be used to detect the touch to the display element or the protective screen.

The display element 102 may be implemented as any display module, display means, display device etc. For example, the display element 102 may comprise a flat panel display, e.g. a Liquid Crystal Display (LCD), a plasma display, an Organic Light Emitting Diode display (OLED), a quantum dot display or a Micro LED display. Alternatively or additionally, the display element 102 may comprise a projection surface of a projection display. The protective screen 104 may be implemented as any (at least semi-transparent) protective module, means for protection or protective device. The protective screen 104 may be or comprise an at least semi-transparent material, e.g. a (toughened) glass or an at least semi-transparent plastic. The protective screen 104 may be arranged between the display element 102 and a finger of a user performing the touch operation. In at least some examples, the protective screen 104 may (completely) overlap the display element 102. For example, a vertical distance between the display element 102 and the protective screen 104 may be smaller than 2 mm (or smaller than 1 mm, smaller than 500 μm, smaller than 200 μm).

In various examples, the at least one radar transmitter component 12 and/or the at least one radar receiver component 14 may be covered (e.g. overlapped or protected) by the protective screen covering the display element. This may enable a substantially flat construction of the surface to be touched. For example, the at least one radar transmitter component 12 and/or the at least one radar receiver component 14 may be arranged between the protective screen 104 and a backside of the touch screen module 100. For example, the at least one radar transmitter component 12 and/or the at least one radar receiver component 14 may be arranged below the protective screen 104 covering the display element 102. Additionally or alternatively, the at least one radar transmitter component 12 and/or the at least one radar receiver component 14 may be in contact with the protective screen 104 covering the display element 102. For example, the at least one radar transmitter component 12 and/or the at least one radar receiver component 14 may be attached to (e.g. glued to or fastened to) the protective screen 104 covering the display element 102. The protective screen 104 may be at least a part of the front side of the touch screen module 100. For example, the transmitters and receivers can be mounted below the screen glass, touching it or even mounted (connected) to it. Furthermore, the RFEMs can be located in the edges of the screen or even below the screen (for touch screen detection, low levels of radar signals may be used, so the loss of placing the RFEM below the screen can be tolerable). For example, the front side of the touch screen module 100 may comprise the surface to be touched.

In various examples, the device 10 may comprise two or more radar transceiver components each comprising a radar transmitter component 12 and a radar receiver component 14. A first radar transceiver component of the two or more radar transceiver components may be arranged at a first side of the display element 102 and a second radar transceiver component of the two or more radar transceiver components may be arranged at a second side of the display element 102. Alternatively or additionally, a first radar transmitter component 12 or a first radar receiver component 14 may be arranged at the first side of the display element 102 and a second radar transmitter component 12 or a second radar receiver component 14 may be arranged at the second side of the display element 102. The first side of the display element 102 may be different from the second side of the display element. This may avoid or reduce a shadowing of the transmitted electromagnetic radiation caused by a hand of a user of the touch screen. Alternatively or additionally, a first radar transmitter component 12 or a first radar receiver component 14 may be arranged at the first side of the display element 102 and a second radar transmitter component 12 or a second radar receiver component 14 may be arranged at the second side of the display element 102. For example, multiple RFEMs may be located in different locations of the device. This may allow for selecting and operating the non-blocked RFEMs or for operating the RFEMs in an array, example: one RFEM transmitting and a second RFEM receiving, or any other combination (the most basic combination may be that the same RFEM is both transmitting and receiving).

In at least some examples, the control module 16 may be configured to choose the first radar transceiver (or the first radar transmitter component) or the second radar transceiver (or the second radar transmitter component) for detecting the touch input based on a shadowing of electromagnetic radiation transmitted by the radar transmitter component of the first radar transceiver (e.g. the first radar transmitter component) or of electromagnetic radiation transmitted by the radar transmitter component of the second radar transceiver (e.g. the second radar transmitter component). For example, the control module 16 may be configured to detect a blocking or shadowing (e.g. by a palm of a user) of the electromagnetic radiation transmitted by the first radar transceiver (or of the second radar transceiver) and use the second radar transceiver (or the first radar transceiver) for detecting the touch input instead. This may further avoid or reduce a shadowing of the transmitted electromagnetic radiation caused by a hand of a user of the touch screen.

FIG. 2 further shows a block diagram of a touch screen apparatus 100 comprising the apparatus 10 as introduced in connection with FIG. 1. The surface to be touched corresponds to a display means 102 or to a means for protection 104 covering the display means 102.

More details and aspects of the touch screen module 100 and/or the touch screen apparatus 100 are mentioned in connection with the proposed concept or one or more examples described above (e.g. FIG. 1). The touch screen module 100 and/or the touch screen apparatus 100 may comprise one or more additional optional features corresponding to one or more aspects of the proposed concept or one or more examples described above or below.

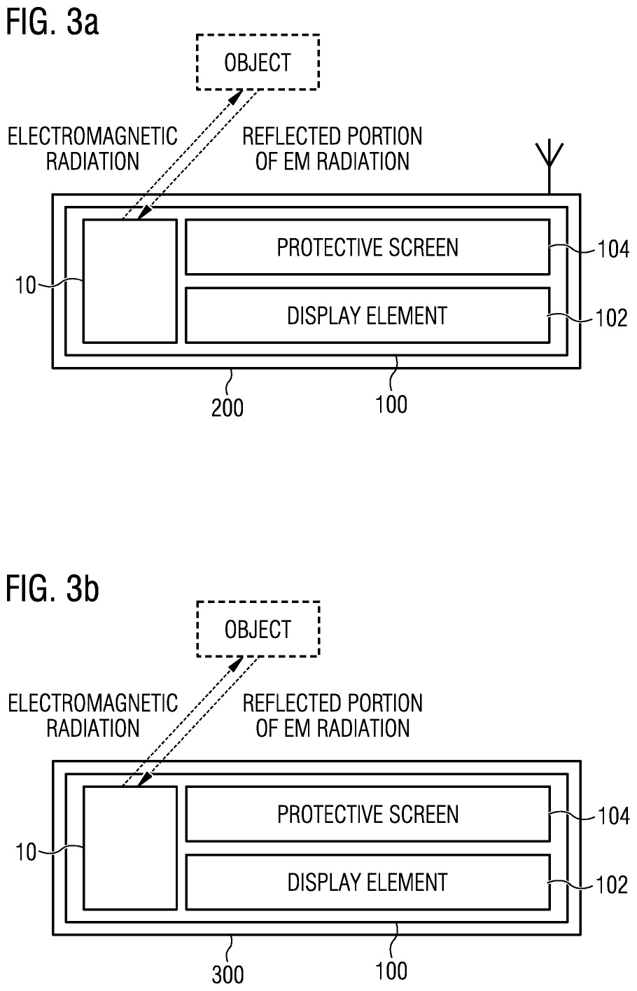

FIG. 3a shows a block diagram of a mobile terminal 200 comprising a touch screen module 100, e.g. the touch screen module as introduced in connection with FIG. 2. For example, the mobile terminal 200 may be any mobile device, e.g. a cell phone, a mobile phone, a mobile transceiver, a tablet computer, a convertible computer, a phablet or a wearable computer.

For example, the control module 16 may be implemented by a central processing unit of the mobile terminal 200. This may reduce a complexity and/or cost of the touch screen, as available processor power may be used. For example, the central processing unit of the mobile terminal 200 may be configured to obtain the information related to the received portion of the electromagnetic radiation from the at least one radar receiver component 14. For example, the control module 16 may be implemented as a driver within an operating system of the mobile terminal 200. Alternatively, the control module 16 may be implemented by an integrated circuit separate from the central processing unit of the mobile terminal 200.

FIG. 3a further shows a block diagram of a mobile terminal 200 comprising a touch screen apparatus 100, e.g. the touch screen apparatus as introduced in connection with FIG. 2.

More details and aspects of the mobile terminal 200 are mentioned in connection with the proposed concept or one or more examples described above (e.g. FIGS. 1 to 2). The mobile terminal 200 may comprise one or more additional optional features corresponding to one or more aspects of the proposed concept or one or more examples described above or below.

FIG. 3b shows a block diagram of a touch screen computer 300 comprising a touch screen module 100, e.g. the touch screen module as introduced in connection with FIG. 2. For example, the touch screen computer may be a laptop computer comprising a touch screen, a convertible computer, a tablet computer, an in-car computer system, a graphics tablet, a television, a presentation computer, a table-sized touch computer or a virtual whiteboard. The control module 16 may be implemented by a central processing unit of the touch screen computer. This may reduce a complexity and/or cost of the touch screen, as available processor power may be used. For example, the central processing unit of the touch screen computer 300 may be configured to obtain the information related to the received portion of the electromagnetic radiation from the at least one radar receiver component 14. For example, the control module 16 may be implemented as a driver within an operating system of the touch screen computer 300. Alternatively, the control module 16 may be implemented by an integrated circuit separate from the central processing unit of the touch screen computer 300.

FIG. 3b further shows a block diagram of a touch screen computer 300 comprising a touch screen apparatus 100, e.g. the touch screen apparatus as introduced in connection with FIG. 2.

More details and aspects of the touch screen computer 300 are mentioned in connection with the proposed concept or one or more examples described above (e.g. FIGS. 1 to 3a). The touch screen computer 300 may comprise one or more additional optional features corresponding to one or more aspects of the proposed concept or one or more examples described above or below.

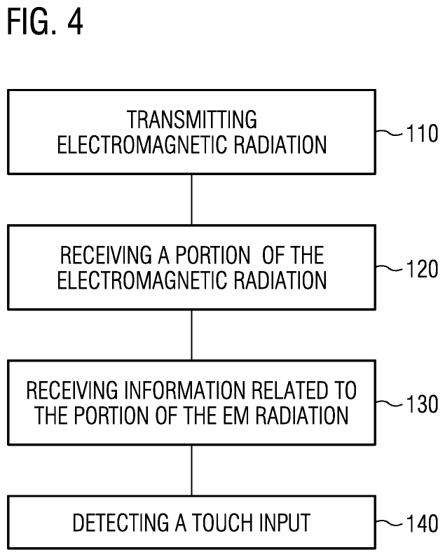

FIG. 4 shows a flow diagram of a method for detecting a touch input to a surface. The method comprises transmitting 110 electromagnetic radiation in a radio frequency spectrum. The method further comprises receiving 120 a portion of the electromagnetic radiation reflected by an object performing the touch input to the surface. The method further comprises receiving 130 information related to the received portion of the electromagnetic radiation. The method further comprises detecting 140 the touch input to the surface based on the information related to the received portion of the electromagnetic radiation.

Using radar to detect the touch input to the surface may allow the construction of thinner touch screens at a cost that may be lower than a cost of capacitive touch screens. Furthermore, through adjustments to a region, in which the touch may be detected, through adjustments to a temporal and/or through adjustments to a spatial resolution, an energy consumption of a radar-based touch screen may be lower than an energy consumption of a capacitive touch screen. Additionally, larger touch screens may be constructed using radar technology with little or no loss to a precision of the detection of the touch.

At least some examples are related to mobile devices touch screen based on mm-Wave radar.

Many mobile devices (phones, tablets, PC, smart watch etc.) and non-mobile devices (car display, TV, etc.) have an integrated touch-screen. High-end touch screens provide good user experience, but may have the following issues:
1. Thicker screen (e.g. the solution has over all very large foot-print)
2. High cost (example: a laptop computer with and without touch screen may cost ˜60$ more)
3. High power consumption (in PCs, battery life time difference between touch screen enable and disable presents up to ˜20% difference)
4. Capacitive touch screens (high-end) may be based on big mesh of wires, thus they are susceptible to noise peaking from the environment
5. Limited resolution, due to limited number of “capacitance sensors”
6. Limited detection when a person is wearing gloves

The basic principle of at least some examples may be to eliminate the need for a touch screen sensor that covers the device screen. Rather than this, very small touch-screen radar (TS-radar) detectors may be placed on the edges under the display screen (two to four detectors, size of each detector ˜2-8 mm²). These radar detectors may be capable of determining the position of an object (human finger or any other object like a stylus pen) in X-Y-Z axis in sub-millimeter precision.

The TS-radar might operate in two modes: very low power proximity detection, if an activity is detected the radar might switch to scanning mode. High frequency radar and close detection range means that the finger positioning may be fast, thus sort bursts on scanning may be enough to provide the required X-Y-Z data for touch screen functionally.

This way, an accurate, low power, small and accurate touch screen sensor may be implemented.

Other high-end touch screens may be implemented using capacitive sensors.
1. There are two main types:
   a. on-cell: additional layers on top of the LCD display implementing the capacitance sensors
   b. in-cell: the capacitance sensors are implemented as part of the LCD display In-cell touch screen sensors may reduce ˜0.5 mm from the thickness of the display panel, but they may increase the cost of the device. Therefore most of the market uses on-cell touch screens. At least some examples might not add any thickness to the display (lower than the on-cell and in-cell) and may add very small cost (e.g. lower than on-cell and in-cell sensors).
2. Capacitive touch screen displays may require an active device to drive the capacitors and estimate the capacitance change (e.g. capacitive controller). At least some examples might not require a dedicated analog/digital controller, a processor may be used to run the estimation of the X-Y-Z positioning (e.g. at a (very) low updated rate).
3. Capacitive touch screen accuracy may be limited to the number of “sensing capacitors”, this may limit the resolution (bigger screen may lead to worse resolution, higher cost and higher power). Examples may use a radar to scan the screen, therefore it might almost not be affected by the size of the screen.

At least some examples may be better in: cost, size, accuracy and power consumption

In order to implement a touch screen based on radar, small radar sensors may be placed on the boundaries of the device under the protective glass. This means that the displays according to at least some examples might include (only) the LCD and protective glass.

The number of radar detectors and location may vary from one at the top of the device to a higher number, e.g. in case parts of the display might be covered by human hands during the operation of the touch screen.

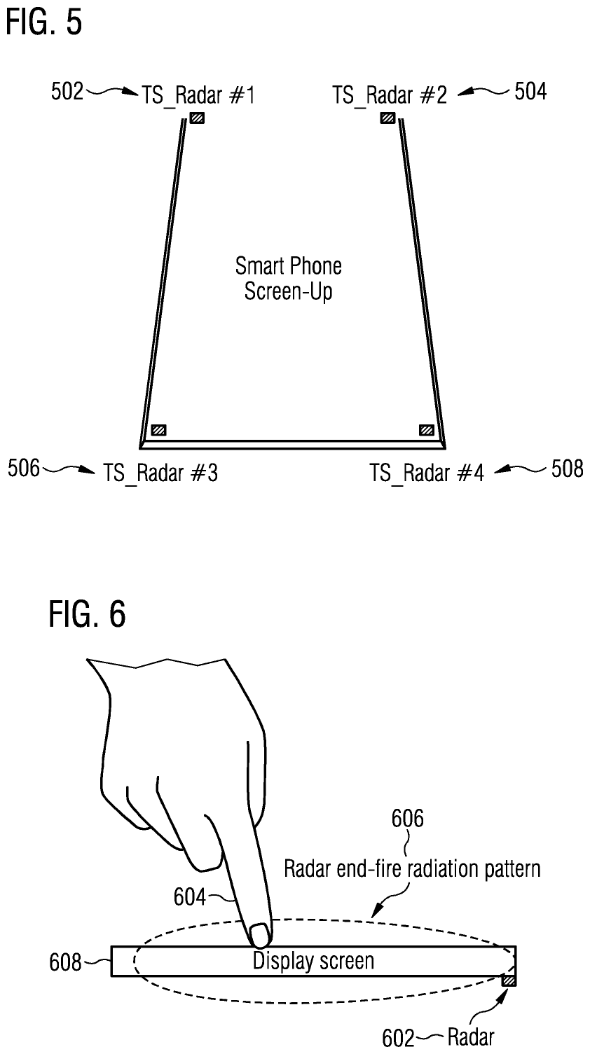

FIG. 5 shows a block diagram of a smart phone with four radar sensors (detectors) 502; 504; 506 and 508, which may allow touch screen detection while parts of the phone are covered by human hands. For example, the four radar sensors may be implemented by or comprise the at least one radar transmitter component 12 and the at least one radar receiver component 14 as introduced in connection with FIG. 1.

The radar sensors may be implemented using a phased array transceiver, capable of stirring the beam in X-Y-Z axis and detecting sub-millimeter motion.

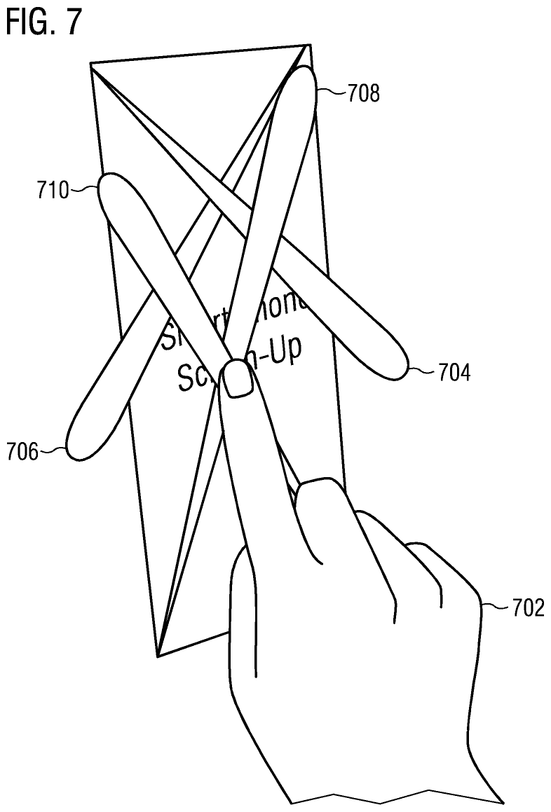

FIG. 6 shows a schematic diagram of a radar phased array antenna end-fire radiation pattern 606. FIG. 6 may illustrate the option of detecting a human finger 604 touching the display screen glass 608. The radar antennas of radar 602 may be designed or configure to provide good end-fire radiation pattern, detecting objects touching the screen.

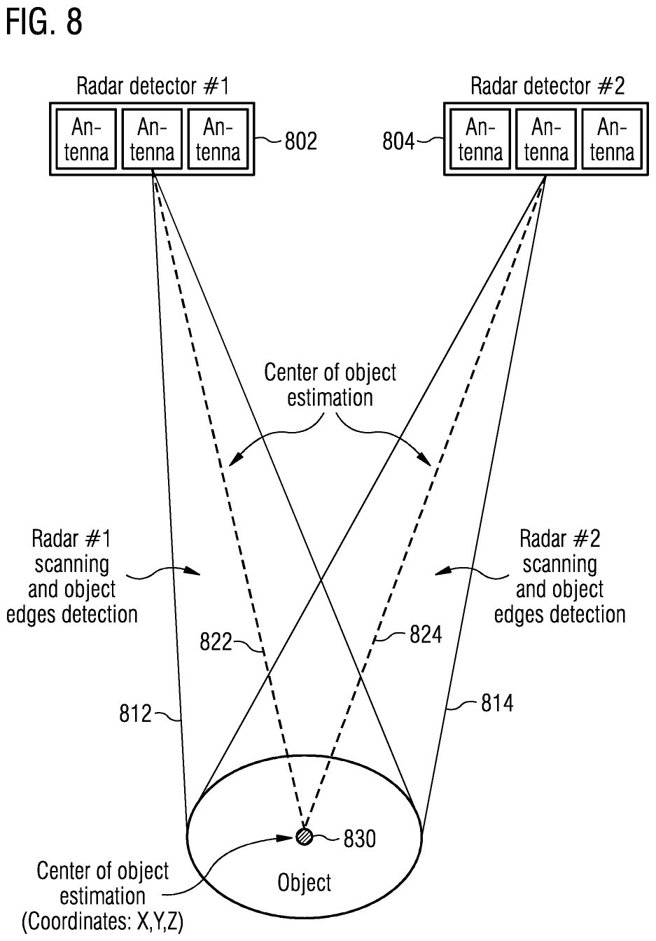

FIG. 7 illustrates of a schematic diagram of touch screen scanning and detecting a human finger 702, by scanning with multiple radar detectors (transmitting electromagnetic radiation at radiation patterns 704, 706, 708 and 710, some of which might be blocked by the hand). FIG. 8 shows a schematic diagram of an object scanned by two radar detectors 802; 804 (each comprising three antennas), with electromagnetic radiation transmission patterns 812; 814 (user for scanning and object edges detection), and estimation of the object center coordinate 830 (e.g. the x-y-z position of the object touching the surface) based on the center 822; 824 of the electromagnetic radiation transmission patterns 812; 814. The principle may be done using a single radar detector. In this case the number of TX and RX antennas (e.g. of the at least one radar transmitter component 12 and/or the at least one radar receiver component 14) might be higher.

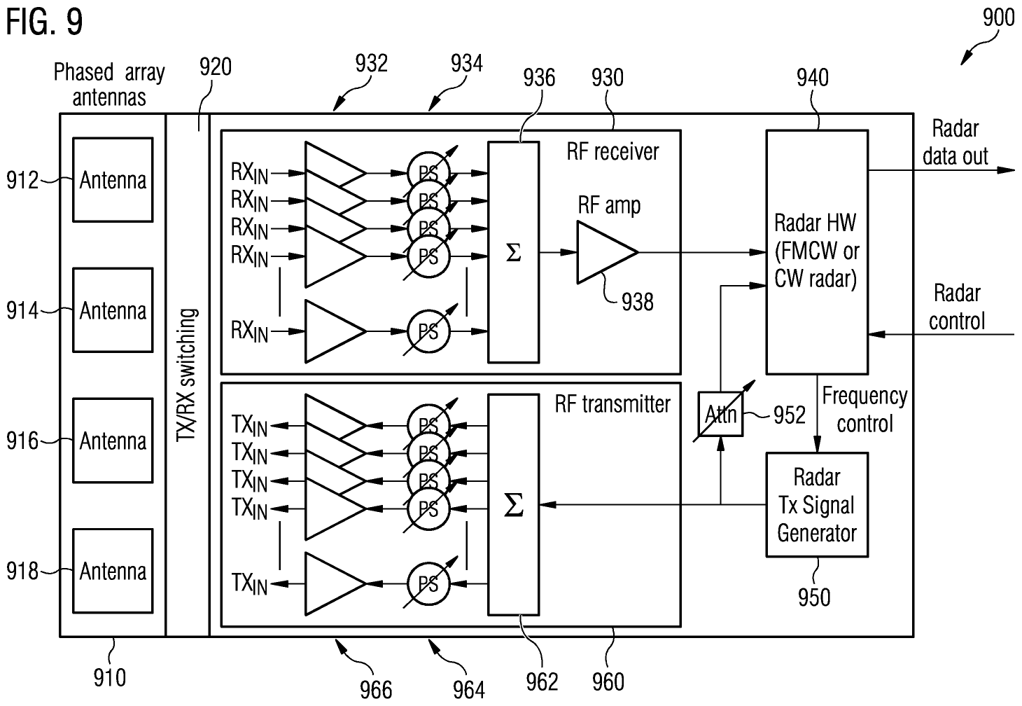

FIG. 9 shows a schematic diagram of a radar detector 900 (e.g. the device or apparatus 10 of FIG. 1). The radar detector 900 comprises phased array antennas 910 (with antennas 912-918). The radar detector 900 further comprises a TX/RX switching circuit 920, which may be configured to switch or multiplex the phased array antennas between the RF transceiver 930 (e.g. the at least one radar receiver component 14) and the RF transmitter 960 (e.g. the at least one radar transmitter component 12). The radar detector 900 further comprises the RF receiver 930 comprising a plurality of input amplifiers 932 receiving a plurality of input signals RF_{IN} from the phased array antennas 910, a plurality of adjustable phase shifters 934, a combination module 936 to combine the phase-shifted received input signals, and an RF amplifier 938 amplifying the combined signal. The radar detector 900 further comprises radar controller hardware 940 (e.g. the control module 16), e.g. for Frequency-Modulated Continuous Wave radar (FMCW radar) or Continuous Wave radar (CW radar). The radar controller hardware 940 is configured to obtain an output signal from the RF amplifier 938, and to provide radar data (e.g. via the interface introduced in connection with FIG. 1) and to control a frequency of a radar TX signal generator 950 of the radar detector 900. The radar controller hardware 940 may be externally controlled, e.g. via the interface. The radar detector 900 further comprises an adjustable attenuator, configured to provide an attenuated version of a radar TX signal generated by the radar TX signal generator 950 to the radar controller hardware 940. The radar TX signal is further fed to a signal splitter 962 of the RF transmitter 960, configured to provide the split signal to a plurality of adjustable phase shifters 964 configured to phase-shift the signal and output the phase-shifted signal via a plurality of output amplifiers 966 and the phase array antennas 910 as amplified output signals TX_{IN}.

The Radar may be based on a phased array mm-Wave transceiver (e.g. comprising the at least one radar transmitter component 12 and/or the at least one radar receiver component 14) capable of transmitting (the electromagnetic radiation) and receiving the reflected signal (the portion of the electromagnetic radiation reflected by the object) simultaneously and estimating the range of the object. The radar detector may be based on a six-port detector or an I/Q mixer-based down conversion receiver.

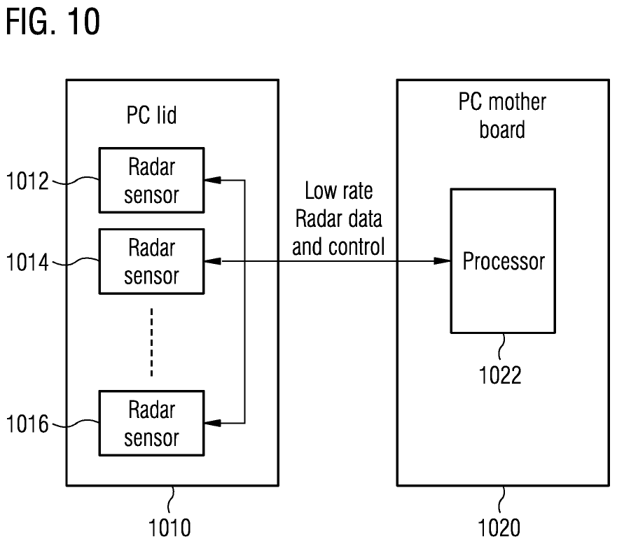

FIG. 10 illustrates a schematic block diagram of a PC comprising small radar detectors/sensors 1012; 1014; 1016 in the lid 1010 (or the boundary on a phone) and moving the processing to the motherboard 1020 (e.g. to the processor 1022) via a slow (low data rate) control and data connection.

The basic implementation of the mmW (Millimeter-Wave) radar detector may require low power, it might comprise (only) short bursts of radar TX signals (low power, since the distance is short) and a simple DSP for X-Y-Z positon detection. The capacitive touchscreen sensor may have to sweep a big matrix of capacitors, so even if each “point” in the matrix consumes average current of ˜20 uA, a high resolution screen may consume tens of mA.

A conventional touch screen may have to sweep the screen continuously even if there is no activity in touching the screen. In at least some examples, the radar based touchscreen may start the operation as a low power low resolution proximity detector, only after the detection of an object near the screen the radar changes to high resolution sweeping mode

Although examples may be general and can be implemented in a variety of RF frequencies (example: 24 GHz, 60 GHz, 77 GHz, 94 GHz, 122 GHz etc.), the following numbers are based on a 60 GHz design.

For a 4 TX and 4 RX radar (comprising four 60 GHz LNAs (Low Noise Amplifier), four RX phase shifters, four 60 GHz PAs (Power Amplifier), four TX phase shifters, comb+routing, a synthesizer, direct current power, a six-port (radar module), four radar phase detectors and analog-to-digital-converters and miscellaneous other circuits), an RFIC (Radio Frequency Integrated Circuit) size of 3.2 mm² may be required. A small 60 GHz RFEM (Radio frequency Front End Module) may be done on FR4 (fiberglass reinforced epoxy laminated) HDI (High Density Interconnect) substrate with a size of ˜15 mm². After testing, assembly and yield, a single RFEM might cost around 0.4$ (using a 28 nm process).

At maximum power, the 4 TX and 4 RX radar may consume a current 211.5 mW of power (max power, all 4 TX and RX are active, passive phase shifters). Assuming that a single distance (or angle of arrival) time is louses, the power consumption may be calculated as a frequency of fs (how many times per second is the “screen sweeped”). In standby mode, one RFEM and low rate of screen monitoring might be used. At 10 fs (and a duty cycle of 0.01%), an average power consumption may be 0.021 mW, at 100 fs (and a duty cycle of 0.1%), the average power consumption may be 0.21 mW. If touch activity is detected, the number of RFEMs and fs may be increased in order to improve the resolution and detect multiple “touching points”. With two RFEM active, at 100 fs (duty cycle 0.1%), the average power consumption may be 0.42 mW, at 1000 fs (duty cycle 1%), the average power consumption may be 4.23 mW. With four RFEM active, at 100 fs (duty cycle 0.1%), the average power consumption may be 0.85 mW, at 1000 fs (duty cycle 1%), the average power consumption may be 8.46 mW.

The aspects and features mentioned and described together with one or more of the previously detailed examples and figures, may as well be combined with one or more of the other examples in order to replace a like feature of the other example or in order to additionally introduce the feature to the other example.

A first example is a device 10 for detecting a touch input to a surface. The device 10 comprises at least one radar transmitter component 12 configured to transmit electromagnetic radiation in a radio frequency spectrum. The device 10 further comprises at least one radar receiver component 14 configured to receive a portion of the electromagnetic radiation reflected by an object performing the touch input to the surface. The device 10 further comprises a control module 16 configured to receive information related to the portion of the electromagnetic radiation received by the at least one radar receiver component 14, and to detect the touch input to the surface based on the information related to the portion of the electromagnetic radiation received by the at least one radar receiver component 14.

In example 2, the control module 16 is configured to detect the touch input to the surface based on a phase shift of the received portion of the electromagnetic radiation relative to the transmitted electromagnetic radiation.

In example 3 the at least one radar transmitter component 12 is configured to transmit the electromagnetic radiation in a millimeter band.

In example 4, the control module 16 is configured to determine a position of the object relative to the surface based on the information related to the portion of the electromagnetic radiation received by the at least one radar receiver component 14, and the control module 16 is configured to provide information related to the position of the object via an interface.

In example 5, the control module 16 is configured to determine the position of the object within a two-dimensional or within a three-dimensional coordinate system.

In example 6, the control module 16 is configured to determine the position of the object at a distance of up to 30 cm from the surface.

In example 7, the at least one radar transmitter component 12 is configured to sweep a region with the electromagnetic radiation.

In example 8, the control module 16 is configured to specify the region to be sweeped by the at least one radar transmitter component 12 based on the detected touch input.

In example 9, the control module 16 is configured to control properties of the sweep based on at least one element of the group of a number of detected touches to the surface, a desired spatial or temporal resolution of the touch detection and a type of application to be controlled by the detected touch.

In example 10, the control module 16 is configured to provide information related to a phase shift of the portion of the electromagnetic radiation reflected by the object at a beam angle of the sweep via an interface. Alternatively or additionally, the control module 16 is configured to provide information related to a power reading at the at least one radar receiver component 14 at a beam angle of the sweep via the interface.

In example 11, the control module 16 is configured to detect a presence of the object in proximity of the surface within a first time interval, and the control module 16 is configured to determine a position of the object relative to the surface within a second time interval.

In example 12, the at least one radar transmitter component 12 is configured to sweep a first region with the electromagnetic radiation during the first time interval, and the at least one radar transmitter component 12 is configured to sweep a second region during the second time interval, the first region is larger than the second region.

In example 13, the at least one radar transmitter component 12 is configured to sweep a region during the first time interval using a first lower temporal resolution, and the at least one radar transmitter component 12 is configured to sweep a region during the second time interval using a second higher temporal resolution.

In example 14, the control module 16 is configured to estimate a position of the object relative to the surface within the first time interval, and the control module 16 is configured to specify a region to be sweeped by the at least one radar transmitter component 12 within the second time interval based on the estimated position of the object.

In example 15, the at least one radar transmitter component 12 comprises at least one phased array antenna, and the at least one radar transmitter component 12 is configured to sweep a region with the electromagnetic radiation using the at least one phased array antenna.

In example 16, an electromagnetic radiation pattern of the at least one phased array antenna is a directed pattern extending along the surface.

In example 17, the at least one radar transmitter component 12 is configured to transmit the electromagnetic radiation using a synthetic aperture radar.

In example 18, the device 10 comprises at least two radar transmitter components 12 and at least two radar receiver components 14.

Example 19 is a touch screen module 100 comprising the device 10 according to one of the previous examples, wherein the surface to be touched corresponds to a display element 102 or to a protective screen 104 covering the display element 102.

In example 20, the at least one radar transmitter component 12 and/or the at least one radar receiver component 14 are covered by the protective screen covering the display element.

In example 21, the at least one radar transmitter component 12 and/or the at least one radar receiver component 14 are arranged below the protective screen 104 covering the display element 102. Alternatively or additionally, the at least one radar transmitter component 12 and/or the at least one radar receiver component 14 are in contact with the protective screen 104 covering the display element 102. Alternatively or additionally, the at least one radar transmitter component 12 and/or the at least one radar receiver component 14 are attached to the protective screen 104 covering the display element 102.

In example 22, the device 10 comprises two or more radar transceiver components each comprising a radar transmitter component 12 and a radar receiver component 14, a first radar transceiver component of the two or more radar transceiver components is arranged at a first side of the display element 102, and a second radar transceiver component of the two or more radar transceiver components is arranged at a second side of the display element 102, and the first side of the display element 102 is different from the second side of the display element.

In example 23, the control module 16 is configured to choose the first radar transceiver or the second radar transceiver for detecting the touch input based on a shadowing of electromagnetic radiation transmitted by the radar transmitter component of the first radar transceiver or of electromagnetic radiation transmitted by the radar transmitter component of the second radar transceiver.

Example 24 is a mobile terminal 200 comprising the touch screen module 100 according to one of the examples 19 to 23.

In example 26, the control module 16 (of example 24) is implemented by a central processing unit of the mobile terminal 200, or the control module 16 is implemented by an integrated circuit separate from the central processing unit of the mobile terminal 200.

Example 26 is a touch screen computer 300 comprising the touch screen module 100 according to one of the examples 19 to 23, and the control module 16 is implemented by a central processing unit of the touch screen computer.

Example 27 is an apparatus 10 for detecting a touch input to a surface. The apparatus 10 comprises at least one means for transmitting 12 electromagnetic radiation in a radio frequency spectrum. The apparatus 10 further comprises at least one means for receiving 14 a portion of the electromagnetic radiation reflected by an object performing the touch input to the surface. The apparatus 10 further comprises a means for controlling 16 configured for receiving information related to the portion of the electromagnetic radiation received by the at least one means for receiving 14 and configured for detecting the touch input to the surface based on the information related to the portion of the electromagnetic radiation received by the at least one means for receiving 14.

In example 28, the means for controlling 16 is configured for detecting the touch input to the surface based on a phase shift of the received portion of the electromagnetic radiation relative to the transmitted electromagnetic radiation.

In example 29, the at least one means for transmitting 12 is configured for transmitting the electromagnetic radiation in a millimeter band.

In example 30, the means for controlling 16 is configured for determining a position of the object relative to the surface based on the information related to the portion of the electromagnetic radiation received by the at least one means for receiving 14, and the means for controlling 16 is configured for providing information related to the position of the object via a means for providing.

In example 31, the means for controlling 16 is configured for determining the position of the object within a two-dimensional or within a three-dimensional coordinate system.

In example 32, the means for controlling 16 is configured for determining the position of the object at a distance of up to 30 cm from the surface.

In example 33, the at least one means for transmitting 12 is configured for sweeping a region with the electromagnetic radiation.

In example 34, the means for controlling 16 is configured for specifying the region to be sweeped by the at least one means for transmitting 12 based on the detected touch input.

In example 35, the means for controlling 16 is configured for controlling properties of the sweep based on at least one element of the group of a number of detected touches to the surface, a desired spatial or temporal resolution of the touch detection and a type of application to be controlled by the detected touch.

In example 36, the means for controlling 16 is configured for providing information related to a phase shift of the portion of the electromagnetic radiation reflected by the object at a beam angle of the sweep via a means for communication. Alternatively or additionally, the means for controlling 16 is configured for providing information related to a power reading at the at least one means for receiving 14 at a beam angle of the sweep via the means for communication.

In example 37, the means for controlling 16 is configured for detecting a presence of the object in proximity of the surface within a first time interval, and the means for controlling 16 is configured for determining a position of the object relative to the surface within a second time interval.

In example 38, the at least one means for transmitting 12 is configured for sweeping a first region with the electromagnetic radiation during the first time interval, and the at least one means for transmitting 12 is configured for sweeping a second region during the second time interval, the first region is larger than the second region.

In example 39, the at least one means for transmitting 12 is configured for sweeping a region during the first time interval using a first lower temporal resolution, and the at least one means for transmitting 12 is configured for sweeping a region during the second time interval using a second higher temporal resolution.

In example 40, the means for controlling 16 is configured for estimating a position of the object relative to the surface within the first time interval, and the means for controlling 16 is configured for specifying a region to be sweeped by the at least one means for transmitting 12 within the second time interval based on the estimated position of the object.

In example 41, the at least one means for transmitting 12 comprises at least one phased array antenna, and the at least one means for transmitting 12 is configured for sweeping a region with the electromagnetic radiation using the at least one phased array antenna.

In example 42, an electromagnetic radiation pattern of the at least one phased array antenna is a directed pattern extending along the surface.

In example 43, the at least one means for transmitting 12 is configured for transmitting the electromagnetic radiation using a synthetic aperture radar.

In example 44, the apparatus 10 comprises at least two means for transmitting 12 and at least two means for receiving 14.

Example 45 is a touch screen apparatus 100 comprising the apparatus 10 according to one of the examples 27 to 44, wherein the surface to be touched corresponds to a display means 102 or to a means for protection 104 covering the display means 102.

In example 46, the at least one means for transmitting 12 and/or the at least one means for receiving 14 are covered by the means for protection 104 covering the display means 102.

In example 47, the at least one means for transmitting 12 and/or the at least one means for receiving 14 are arranged below the means for protection 104 covering the display means 102. Alternatively or additionally, the at least one means for transmitting 12 and/or the at least one means for receiving 14 are in contact with the means for protection 104 covering the display means 102. Alternatively or additionally, the at least one means for transmitting 12 and/or the at least one means for receiving 14 are attached to the means for protection 104 covering the display means 102.

In example 48, the device 10 comprises two or more means for transceiving each comprising a means for transmitting 12 and a means for transmitting 14, a first means for transceiving of the two or more means for transceiving is arranged at a first side of the display means 102, and a second radar transceiver component of the two or more radar transceiver components is arranged at a second side of the display means 102, the first side of the display means 102 is different from the second side of the display means 102.

In example 49, the means for controlling 16 is configured for choosing the first means for transceiving or the second means for transceiving for detecting the touch input based on a shadowing of electromagnetic radiation transmitted by the means for transmitting of the first means for transceiving or of electromagnetic radiation transmitted by the means for transmitting of the second means for transceiving.

Example 50 is a method for detecting a touch input to a surface. The method comprises Transmitting 110 electromagnetic radiation in a radio frequency spectrum. The method further comprises Receiving 120 a portion of the electromagnetic radiation reflected by an object performing the touch input to the surface. The method further comprises Receiving 130 information related to the received portion of the electromagnetic radiation. The method further comprises Detecting 140 the touch input to the surface based on the information related to the received portion of the electromagnetic radiation.

In example 51, the detecting 140 of the touch input to the surface is based on a phase shift of the received portion of the electromagnetic radiation relative to the transmitted electromagnetic radiation.

In example 52, the electromagnetic radiation is transmitted 110 in a millimeter band.

In example 53, the method comprises determining a position of the object relative to the surface based on the information related to the received portion of the electromagnetic radiation, and providing information related to the position of the object via an interface.

In example 54, the position of the object is detected or specified within a two-dimensional or within a three-dimensional coordinate system.

In example 55, the position of the object is detected at a distance of up to 30 cm from the surface.

In example 56, the transmitting 110 of the electromagnetic radiation sweeps a region with the electromagnetic radiation.

In example 57, the method further comprises determining the region to be sweeped based on the detected touch input.

In example 58, the method further comprises controlling properties of the sweep based on at least one element of the group of a number of detected touches to the surface, a desired spatial or temporal resolution of the touch detection and a type of application to be controlled by the detected touch.

In example 59, the method comprises providing information related to a phase shift of the portion of the electromagnetic radiation reflected by the object at a beam angle of the sweep via an interface. Alternatively or additionally, the method comprises providing information related to a power reading at least one radar receiver component transmitting the electromagnetic radiation at a beam angle of the sweep via the interface.

In example 60, the method comprises detecting a presence of the object in proximity of the surface within a first time interval, and determine a position of the object relative to the surface within a second time interval.

In example 61, the transmitting 110 of the electromagnetic radiation comprises sweeping a first region with the electromagnetic radiation during the first time interval, and the transmitting 110 of the electromagnetic radiation comprises sweeping a second region during the second time interval, the first region is larger than the second region.

In example 62, the transmitting 110 of the electromagnetic radiation comprises sweeping a region during the first time interval using a first lower temporal resolution, the transmitting 110 of the electromagnetic radiation comprises sweeping a region during the second time interval using a second higher temporal resolution.

In example 63, the method comprises estimating a position of the object relative to the surface within the first time interval, and specifying a region to be sweeped within the second time interval based on the estimated position of the object.

In example 64, the transmitting 110 of the electromagnetic radiation comprises sweeping a region with the electromagnetic radiation using at least one phased array antenna.

In example 65, an electromagnetic radiation pattern of the at least one phased array antenna is a directed pattern extending along the surface.

In example 66, the transmitting 110 of the electromagnetic radiation comprises transmitting the electromagnetic radiation using a synthetic aperture radar.

Example 67 is a machine readable storage medium including program code, when executed, to cause a machine to perform the method of one of the examples 50 to 66.

Example 68 is a computer program having a program code for performing the method of at least one of the examples 50 to 66, when the computer program is executed on a computer, a processor, or a programmable hardware component.

Example 69 is a machine readable storage including machine readable instructions, when executed, to implement a method or realize an apparatus as claimed in any pending claim or as introduced in any example.

Example 70 is a mobile terminal 200 comprising the touch screen apparatus 100 according to one of the examples 45 to 49.

Examples may further be or relate to a computer program having a program code for performing one or more of the above methods, when the computer program is executed on a computer or processor. Steps, operations or processes of various above-described methods may be performed by programmed computers or processors. Examples may also cover program storage devices such as digital data storage media, which are machine, processor or computer readable and encode machine-executable, processor-executable or computer-executable programs of instructions. The instructions perform or cause performing some or all of the acts of the above-described methods. The program storage devices may comprise or be, for instance, digital memories, magnetic storage media such as magnetic disks and magnetic tapes, hard drives, or optically readable digital data storage media. Further examples may also cover computers, processors or control units programmed to perform the acts of the above-described methods or (field) programmable logic arrays ((F)PLAs) or (field) programmable gate arrays ((F)PGAs), programmed to perform the acts of the above-described methods.

The description and drawings merely illustrate the principles of the disclosure. Furthermore, all examples recited herein are principally intended expressly to be only for pedagogical purposes to aid the reader in understanding the principles of the disclosure and the concepts contributed by the inventor(s) to furthering the art. All statements herein reciting principles, aspects, and examples of the disclosure, as well as specific examples thereof, are intended to encompass equivalents thereof.

A functional block denoted as “means for . . .” performing a certain function may refer to a circuit that is configured to perform a certain function. Hence, a “means for s.th.” may be implemented as a “means configured to or suited for s.th.”, such as a device or a circuit configured to or suited for the respective task.

Functions of various elements shown in the figures, including any functional blocks labeled as “means”, “means for providing a sensor signal”, “means for generating a transmit signal.”, etc., may be implemented in the form of dedicated hardware, such as “a signal provider”, “a signal processing unit”, “a processor”, “a controller”, etc. as well as hardware capable of executing software in association with appropriate software. When provided by a processor, the functions may be provided by a single dedicated processor, by a single shared processor, or by a plurality of individual processors, some of which or all of which may be shared. However, the term “processor” or “controller” is by far not limited to hardware exclusively capable of executing software, but may include digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included.

A block diagram may, for instance, illustrate a high-level circuit diagram implementing the principles of the disclosure. Similarly, a flow chart, a flow diagram, a state transition diagram, a pseudo code, and the like may represent various processes, operations or steps, which may, for instance, be substantially represented in computer readable medium and so executed by a computer or processor, whether or not such computer or processor is explicitly shown. Methods disclosed in the specification or in the claims may be implemented by a device having means for performing each of the respective acts of these methods.

It is to be understood that the disclosure of multiple acts, processes, operations, steps or functions disclosed in the specification or claims may not be construed as to be within the specific order, unless explicitly or implicitly stated otherwise, for instance for technical reasons. Therefore, the disclosure of multiple acts or functions will not limit these to a particular order unless such acts or functions are not interchangeable for technical reasons. Furthermore, in some examples a single act, function, process, operation or step may include or may be broken into multiple sub-acts, -functions, -processes, -operations or -steps, respectively. Such sub acts may be included and part of the disclosure of this single act unless explicitly excluded.

Furthermore, the following claims are hereby incorporated into the detailed description, where each claim may stand on its own as a separate example. While each claim may stand on its own as a separate example, it is to be noted that—although a dependent claim may refer in the claims to a specific combination with one or more other claims—other examples may also include a combination of the dependent claim with the subject matter of each other dependent or independent claim. Such combinations are explicitly proposed herein unless it is stated that a specific combination is not intended. Furthermore, it is intended to include also features of a claim to any other independent claim even if this claim is not directly made dependent to the independent claim.

1.-25. (canceled)

26. A device for detecting a touch input to a surface, the device comprising:
at least one radar transmitter component configured to transmit electromagnetic radiation in a radio frequency spectrum;
at least one radar receiver component configured to receive a portion of the electromagnetic radiation reflected by an object performing the touch input to the surface; and
a control module configured to:
receive information related to the portion of the electromagnetic radiation received by the at least one radar receiver component, and
detect the touch input to the surface based on the information related to the portion of the electromagnetic radiation received by the at least one radar receiver component.

27. The device according to claim 26, wherein the control module is configured to detect the touch input to the surface based on a phase shift of the received portion of the electromagnetic radiation relative to the transmitted electromagnetic radiation.

28. The device according to claim 26, wherein the at least one radar transmitter component is configured to transmit the electromagnetic radiation in a millimeter band.

29. The device according to claim 26, wherein the control module is configured to determine a position of the object relative to the surface based on the information related to the portion of the electromagnetic radiation received by the at least one radar receiver component, and wherein the control module is configured to provide information related to the position of the object via an interface.

30. The device according to claim 26, wherein the at least one radar transmitter component is configured to sweep a region with the electromagnetic radiation.

31. The device according to claim 30, wherein the control module is configured to specify the region to be swept by the at least one radar transmitter component, based on the detected touch input.

32. The device according to claim 30, wherein the control module is configured to control properties of the sweep based on at least one element of the group of a number of detected touches to the surface, a desired spatial or temporal resolution of the touch detection and a type of application to be controlled by the detected touch.

33. The device according to claim 26, wherein the control module is configured to detect a presence of the object in proximity of the surface within a first time interval, and wherein the control module is configured to determine a position of the object relative to the surface within a second time interval.

34. The device according to claim 33, wherein the at least one radar transmitter component is configured to sweep a first region with the electromagnetic radiation during the first time interval, and wherein the at least one radar transmitter component is configured to sweep a second region during the second time interval, wherein the first region is larger than the second region.

35. The device according to claim 33, wherein the at least one radar transmitter component is configured to sweep a region during the first time interval using a first lower temporal resolution, and wherein the at least one radar transmitter component is configured to sweep a region during the second time interval using a second higher temporal resolution.

36. The device according to claim 33, wherein the control module is configured to estimate a position of the object relative to the surface within the first time interval, and wherein the control module is configured to specify a region to be swept by the at least one radar transmitter component within the second time interval based on the estimated position of the object.

37. The device according to claim 26, wherein the at least one radar transmitter component comprises at least one phased array antenna, and wherein the at least one radar transmitter component is configured to sweep a region with the electromagnetic radiation using the at least one phased array antenna.

38. The device according to claim 26, wherein an electromagnetic radiation pattern of the at least one phased array antenna is a directed pattern extending along the surface.

39. A touch screen module comprising:
at least one radar transmitter component configured to transmit electromagnetic radiation in a radio frequency spectrum;
at least one radar receiver component configured to receive a portion of the electromagnetic radiation reflected by an object performing a touch input to a display element and/or to a protective screen covering the display element; and
a control module configured to:
receive information related to the portion of the electromagnetic radiation received by the at least one radar receiver component, and
detect the touch input to the surface based on the information related to the portion of the electromagnetic radiation received by the at least one radar receiver component.

40. The touch screen module according to claim 39, wherein the at least one radar transmitter component and/or the at least one radar receiver component are covered by the protective screen covering the display element.

41. The touch screen module according to claim 39, wherein the at least one radar transmitter component and/or the at least one radar receiver component are arranged below the protective screen covering the display element; and/or
wherein the at least one radar transmitter component and/or the at least one radar receiver component are in contact with the protective screen covering the display element; and/or
wherein the at least one radar transmitter component and/or the at least one radar receiver component are attached to the protective screen covering the display element.

42. The touch screen module according to claim 39, further comprising:
two or more radar transceiver components each comprising a radar transmitter component and a radar receiver component, wherein a first radar transceiver component of the two or more radar transceiver components is arranged at a first side of the display element, and wherein a second radar transceiver component of the two or more radar transceiver components is arranged at a second side of the display element, wherein the first side of the display element is different from the second side of the display element.

43. The touch screen module according to claim 42, wherein the control module is configured choose the first radar transceiver or the second radar transceiver for detecting the touch input based on a shadowing of electromagnetic radiation transmitted by the radar transmitter component of the first radar transceiver or of electromagnetic radiation transmitted by the radar transmitter component of the second radar transceiver.

44. An apparatus comprising:
a processor configured to cause a device to detect a touch input to a surface by:
transmitting electromagnetic radiation in a radio frequency spectrum;
receiving a portion of the electromagnetic radiation reflected by an object performing the touch input to the surface;
receiving information related to the portion of the electromagnetic radiation received by the at least one means for receiving, and
detecting the touch input to the surface based on the information related to the portion of the electromagnetic radiation received by the at least one means for receiving.

45. The apparatus according to claim 44, wherein the surface corresponds to a display and/or to a protective covering of the display.
